(19) United States
(12) Patent Application Publication
(10) Pub. No.: US 2022/0049170 A1
(43) Pub. Date: Feb. 17, 2022

(54) APPARATUS FOR TREATING WASTE MATERIAL AND A PRODUCT GAS

(71) Applicant: TEKNOLOGIAN TUTKIMUSKESKUS VTT OY, Espoo (FI)

(72) Inventors: Esa KURKELA, Espoo (FI); Matti NIEMINEN, Espoo (FI)

(73) Assignee: TEKNOLOGIAN TUTKIMUSKESKUS VTT OY, Espoo (FI)

(21) Appl. No.: 17/515,006

(22) Filed: Oct. 29, 2021

Related U.S. Application Data
(62) Division of application No. 14/439,937, filed on Apr. 30, 2015.

(30) Foreign Application Priority Data
Oct. 31, 2012 (FI) 20126130

(51) Int. Cl. C10J 3/52; C10J 3/46; F23J 15/02; G21F 9/32; F23G 5/027; F23J 15/06; F23G 7/00; C10K 1/10; C10K 1/02; G21F 9/34; C10J 3/48; C10J 3/72; C10L 3/00; G21F 9/00; G21F 9/02; G21F 9/30

(52) U.S. Cl. CPC C10J 3/523; C10L 2290/58; F23J 15/025; G21F 9/32; F23G 5/027; F23J 15/06; F23G 7/001; C10K 1/101; C10K 1/024; G21F 9/34; C10J 3/482; C10J 3/72; C10J 3/723; C10L 3/00; G21F 9/001; G21F 9/02; G21F 9/30; C10J 2300/0946; C10J 2300/1606; F23G 2209/18; F23G 2201/303; F23G 2201/301; F23J 2217/104; C10J 2300/1846; C10J 2300/0956; Y02E 20/30; C10J 2300/1246; C10J 2300/1615; C10J 2300/1618; C10J 2300/1628; C10L 2200/0461; C10L 2290/02; C10L 2290/04; C10L 2290/06; C10L 2290/545; C10J 3/463

(57) ABSTRACT

The invention relates to an apparatus for treating waste material including organic components and radioactive agents. In the apparatus the waste material including organic components and radioactive agents are gasified at temperature between 600-950° C. in a fluidized bed reactor to form a gaseous material. The gaseous material is than cooled in a water quenching device so that temperature is between 300-500° C. after the cooling. The solid fraction including radioactive agents is removed from the gaseous material in a in at least one filtration device. A gas scrubbing device then removes sulphur by scrubbing the treated gaseous material after the filtration in order to form a treated gaseous material.

### CROSSREFERENCE TO RELATED APPLICATION

This application is Divisional of U.S. patent application Ser. No. 14/439,937, filed Apr. 30, 2015 which is the U.S. national phase of PCT Application No. PCT/FI2013/050977 filed on Oct. 9, 2013, which claims priority to FI Patent Application No. 20126130 filed on Oct. 31, 2012, the disclosures of which are incorporated in their entirety by reference herein.

### FIELD OF THE INVENTION

The invention relates to an apparatus for treating waste material including organic components and radioactive agents.

### BACKGROUND

It is known from the prior art that radioactively contaminated waste is difficult to treat. Further, disposal of the radioactively contaminated waste is costly.

### OBJECTIVE OF THE INVENTION

The objective of the invention is to disclose a new type apparatus for treating waste material including organic components and radioactive agents. Further, the objective of the invention is to disclose a apparatus for treating contaminated waste material into environmentally safe form. Further, the objective of the invention is to decrease amount of waste material. Further, the objective of the invention is to produce a new gaseous product.

### SUMMARY

The apparatus according to the invention is characterized by what has been presented in the claims.

The invention is based on a method for treating waste material including organic components and radioactive agents. According to the invention, the method comprises steps in order to form a treated gaseous material: the waste material including organic components and radioactive agents which are low-level and/or medium-level radioactive agents is gasified at temperature between 600-950° C. in a reactor to form a gaseous material; the gaseous material is cooled by water quenching so that temperature is between 300-500° C. after the cooling; and solid fraction including radioactive agents is removed from the gaseous material in a gas cleaning step.

Further, the invention is based on an apparatus for treating waste material including organic components and radioactive agents. According to the invention, the apparatus for forming a treated gaseous material comprises: a reactor in which the waste material including organic components and radioactive agents which are low-level and/or medium-level radioactive agents is gasified at temperature between 600-950° C. to form a gaseous material; a cooling step comprising at least one water quenching step in which the gaseous material is cooled so that temperature is between 300-500° C. after the cooling; and a gas cleaning device in which solid fraction including radioactive agents is removed from the gaseous material.

Further, the invention is based on a product gas. According to the invention, the product gas contains treated gaseous material which has been formed from waste material including organic components and radioactive agents which are low-level and/or medium-level radioactive agents so that the waste material including organic components and radioactive agents has been gasified at temperature between 600-950° C. in a reactor to form a gaseous material, the gaseous material has been cooled by water quenching so that temperature is between 300-500° C. after the cooling, and solid fraction including radioactive agents has been removed from the gaseous material in a gas cleaning step.

Preferably, the gaseous material is combustible.

In this context, the radioactive agents refer to any radioactive material, compounds and chemical elements and their derivates. In this context, radioactive agents are low-level and/or medium-level.

In this context, the waste material including organic components and radioactive agents means any material which includes organic and radioactive components. The waste material including organic components and radioactive agents may be selected from the group containing resins, such as resins from nuclear power plant, clothes, such as industrial protective clothing and protective clothing, contaminated wood, contaminated vegetable matter such as corn, straw and hay.

Any reactor known per se can be used in the gasification. Preferably, the reactor can be a fluidized bed reactor, bubbling or circulating fluidized bed reactor or the like. In one embodiment the reactor is fluidized bed reactor. In the fluidized bed reactor hot spots don't form in the reactor bed. Sand, aluminium oxide or other suitable bed material may be used as the bed material.

In one embodiment radioactive agents and other metals may partly vaporize during the gasification. When the gaseous material is cooled so the radioactive agents and other metals which have vaporized during the gasification are condensed and changed back solid form.

It is important that temperature can be controlled in the gasification. It is important for the invention that organic and radioactive agents can be removed. In the gasification the radioactive agents and other metals may partly vaporize. However, because low temperature is used in the gasification so vaporization of metals can be minimized. In the cooling the radioactive agents and other metals are condensed and changed back solid form.

In one embodiment, the waste material including organic components and radioactive agents is gasified at temperature between 600-900° C. in a reactor to form a gaseous material. In one embodiment, the waste material is gasified at temperature between 700-950° C., and in one embodiment between 700-900° C. In one embodiment, the waste material is gasified at temperature between 750-950° C., and in one embodiment between 750-900° C.

In one embodiment, the waste material including organic components and radioactive agents is gasified by air. In a preferred embodiment air ratio is below 1, preferably below 0.7, more preferably below 0.5 and most preferable below 0.4.

In one embodiment, the waste material including organic components and radioactive agents may be dewatered before the gasification. In one embodiment water is removed mechanically from the waste material including organic components and radioactive agents. In one embodiment the waste material including organic components and radioactive agents is dried by the drying device.

In one embodiment the other organic material is added into the waste material including organic components and radioactive agents before the gasification. The other organic material may be selected from the group containing oil, plastic, polymers or the like. It is important that ash content of the other organic material is low.

In one embodiment, the gaseous material is cooled so that temperature is between 350-450° C. after the cooling.

Preferably, the gaseous material is cooled by water quenching. The apparatus comprises water quenching step for cooling the gaseous material. The water quenching step may include one or more devices suitable for carrying out water quenching.

In one embodiment, the gaseous material is cooled by heat exchanger. In one embodiment, the apparatus comprises at least one heat exchanger for cooling the gaseous material.

In one embodiment, the gaseous material is filtered in the gas cleaning step in order to remove solid fraction including radioactive agents. The apparatus comprises at least one filtration device. In one embodiment, the filtration is carried out at temperatures between 300-500° C. It is important that the temperature is not too high because, for example, at temperature 600° C. metals may traverse the filtration device. In one embodiment, the filtration device is hot gas filter. In one embodiment the filtration device includes at least one or more ceramic filter. In one embodiment the filtration device includes at least one or more metal filter, preferably sintered metal filter.

In one embodiment, the treated gaseous material is burnt after the removing of the solid fraction including radioactive agents. Preferably, the treated gaseous material is burnt at temperature over 1000° C. In one embodiment, the apparatus comprises a combustion reactor in which the treated gaseous material is burnt after the removing of the solid fraction including radioactive agents.

In one embodiment, the treated gaseous material or the gas flow of the combustion is post-treated by a gas scrubbing. Preferably, sulphur is removed during the gas scrubbing. In one embodiment, the treated gaseous material may be post-treated by the gas scrubbing directly after the removing of the solid fraction including radioactive agents or alternatively the gas flow may be post-treated by the gas scrubbing after the combustion step which has been done after the removing of the solid fraction including radioactive agents. In one embodiment, the apparatus comprises a gas scrubbing device for post-treating.

In one embodiment sulphur may be removed in connection with the combustion step of the treated gaseous material. However, the sulphur removing is easier to carry out in connection with the gas scrubbing.

In one embodiment, the product gas contains 70-100 vol % treated gaseous material.

In one embodiment, the product gas or the treated gaseous material is used and utilized as a fuel of energy production process. In one embodiment, the product gas or the treated gaseous material is used as a fuel as such or after the gas scrubbing.

The invention provides the advantage that the contaminated waste material can be purified. Thanks to the invention, radioactive fraction can be concentrated and amount of the waste material, and volume of the waste material, can be decreased. By means of the invention even over 90% volume reduction may be achieved in the amount of the radioactive disposal. The formed radioactive fraction can be disposed as any radioactive waste. Further, by means of the invention gaseous fuel can be produced for energy production process.

The apparatus of the invention offers a possibility to treat contaminated waste material cost-effectively and energy-effectively. The present invention provides an industrially applicable, simple and affordable way of producing treated gaseous material. The apparatus of the present invention is easy and simple to realize as a production process.

### BRIEF DESCRIPTION OF THE DRAWINGS

In the following section, the invention will be described with the aid of detailed exemplary embodiments, referring to the accompanying figure wherein

FIG. 1 presents one embodiment of the apparatus according to the invention, and

FIG. 2 presents another embodiment of the apparatus according to the invention.

### DETAILED DESCRIPTION

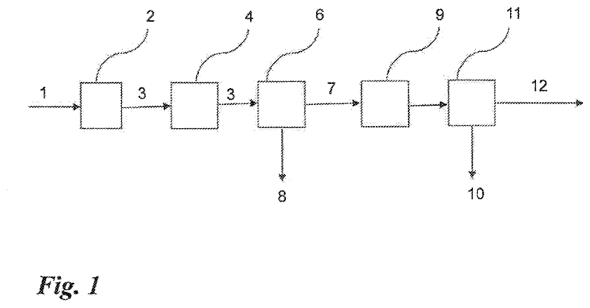

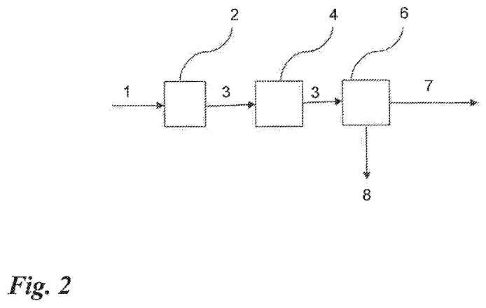

FIGS. 1 and 2 present the apparatuses according to the invention for treating waste material including organic components and radioactive agents.

### Example 1

The apparatus of FIG. 1 comprises a fluidized bed reactor 2 in which the waste resin material 1 including organic components and radioactive agents is gasified at temperature between 750-950° C. to form a gaseous material 3, a water quenching step 4 in which the gaseous material is cooled so that temperature is between 350-450° C. after the cooling, and a metal filtration device 6 in which solid fraction 8 including radioactive agents is removed from the gaseous material 3. The waste resin material 1 may be dewatered before the gasification.

The apparatus comprises a combustion reactor 9 in which the treated gaseous material 7 is burnt at temperature over 1000° C. after the removing of the solid fraction 8 including radioactive agents. Further, the apparatus comprises a gas scrubbing device 11 for post-treating the gas flow after the combustion of the treated gaseous material. Sulphur 10 is removed from the gas flow during the gas scrubbing 11 wherein clean exhaust gas 12 is achieved.

### Example 2

The apparatus of FIG. 2 comprises a fluidized bed reactor 2 in which the waste material 1 including organic components and radioactive agents is gasified at temperature between 600 950° C. to form a gaseous material 3, a heat exchanger 4 in which the gaseous material is cooled so that temperature is between 300-500° C. after the cooling, and a metal filtration device 6 in which solid fraction 8 including radioactive agents is removed from the gaseous material 3. In this example the waste material 1 comprises contaminated clothes, wood and vegetable matters.

The treated gaseous material 7 is used directly as a fuel of energy production process. The treated gaseous material may be post-treated by gas scrubbing before the using as a fuel. Alternatively, the treated gaseous material may be burnt in a combustion reactor and/or post-treated by a gas scrubbing.

The devices used in this invention are known per se in the art, and therefore they are not described in any more detail in this context.

The apparatus according to the invention is suitable in different embodiments for treating different kinds of waste material.

The invention is not limited merely to the examples referred to above; instead many variations are possible within the scope of the inventive idea defined by the claims.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

What is claimed is:

1. An apparatus for treating waste material including organic components and radioactive agents to form a treated gaseous material, the apparatus comprising:
a fluidized bed reactor configured to gasify the waste material including organic components and radioactive agents from the group consisting of resins, clothes, contaminated wood, and contaminated vegetable matter, wherein the radioactive agents are low-level and/or medium-level radioactive agents, using air at an air ratio greater than zero and less than 1 at temperatures between 600-950° C. to form a gaseous material,
a water quenching device configured to quench the gaseous material to temperature which is between 300-500° C. after cooling by water quenching to form a cooled gaseous material,
a gas cleaning device configured to remove a solid fraction by filtration carried out at temperature between 300-500° C. in at least one filtration device, including removing the radioactive agents, from the cooled gaseous material and to form a treated gaseous material, and
a gas scrubbing device configured to remove sulphur by scrubbing from the treated gaseous material after the filtration.

2. The apparatus according to claim 1, further comprising at least one heat exchanger for cooling the gaseous material.

3. The apparatus according to claim 1, wherein the filtration device is hot gas filter.

4. The apparatus according to claim 1, further comprising a combustion reactor in which the treated gaseous material is burnt after the removing of the solid fraction including radioactive agents.

5. The apparatus according to claim 4, wherein the treated gaseous material is burnt at temperature over 1000° C.
